(19) United States
(12) Patent Application Publication
(10) Pub. No.: US 2006/0197067 A1
(43) Pub. Date: Sep. 7, 2006

(54) Radiation-absorbing materials, ophthalmic compositions containing same, and method of treating ophthalmic devices

(76) Inventors: Erning Xia, Penfield, NY (US); Yu-Chin Lai, Pittsford, NY (US); Edmond T. Quinn, Rochester, NY (US)

Correspondence Address: Bausch & Lomb Incorporated, One Bausch & Lomb Place, Rochester, NY, 14604-2701, US

(21) Appl. No.: 11/072,783

(22) Filed: Mar. 4, 2005

(51) Int. Cl. G02F 1/361

(52) U.S. Cl. 252/582

(57) ABSTRACT

An ophthalmic composition includes a hydrophilic radiation-absorbing material, which includes a radiation-absorbing moiety coupled with a hydrophilic moiety. An ophthalmic device immersed in such a composition can obtain a radiation-absorbing property and provide protection to the wearer against such radiation. The ophthalmic composition can be formulated to achieve an effect selected from cleaning, sterilizing, storing, and combinations thereof.

### BACKGROUND OF THE INVENTION

The present invention relates to radiation-absorbing materials, ophthalmic compositions containing the same, and methods of treating ophthalmic devices with such compositions. In particular, the present invention relates to ophthalmic solutions containing hydrophilic radiation-absorbing materials and methods of altering radiation-absorbing characteristics of ophthalmic devices at a point of use.

Harmful effects to the eye from ultraviolet (“UV”) radiation (from about 100 nm to about 400 nm in wavelength) have long been known. UV radiation reaching the eye has wavelengths in the range of UV-B and UV-A (i.e., from about 230 nm to about 400 nm) and has been linked to cornea, lens, and retinal damage, including macular degeneration, and is believed to be a major cause of yellow-cataracts.

More recently, the undesirable effects of high transmittance levels of blue light (wavelengths from about 400 nm to about 500 nm) have received attention. High levels of blue light have also been linked to retinal damage, macular degeneration, retinitis pigmentosa, and night blindness. In addition, blue light tends to be scattered in the atmosphere, especially in haze, fog, rain, and snow, which in part can cause glare, and diminished visual acuity.

In addition to the problems encountered with UV and blue light, which affects the entire population, there are reported in the literature various special requirements based on optical diseases or conditions, and on occupations or activities in which a person engages. For example, a person with cataracts, diabetic retinopathy, corneal dystrophy, albinism, or extreme photophobia will have special visual needs not possessed by the general population. Also, people who engage in certain outdoor sports or activities, e.g., skiers, baseball players, football players, pilots, and boaters are exposed to high levels of UV, blue, and visible light which can affect visual acuity required in such activities. Drivers of motor vehicles also have specific needs in terms of reducing glare and enhancing visual acuity under bright, sunlit driving conditions and reducing headlight glare at night. For these specific needs, alteration of light transmittance over the spectrum of visible light including the blue-violet end of the visible spectrum to the red end of the spectrum may be necessary.

Therefore, there is a need to provide means for eye protection from harmful UV radiation. It is also desirable to provide means for eye protection from blue light, especially the shorter wavelength range of blue light. One approach to satisfy this need has been to provide contact lenses containing compounds for blocking UV radiation. These lenses have been on the market for several years. Such lenses are useful to all who live in areas where bright sunlight is common, and everyone who wears contact lenses can benefit from the type of lenses which block this radiation. Younger persons, whose eye lenses transmit more UV radiation than do those of older persons, also should be concerned with providing protection against this type of radiation.

Typically, UV absorbing compounds have been included in a mixture of monomers, which are polymerized to produce a lens material in the process making the contact lenses. Polymerizable UV absorbing compounds based on benzophenone for producing contact and intraocular lenses appeared in the early 1970s. More recently, substituted 2-phenyl benzotriazole compounds having a polymerizable acrylic group have been used to produce contact lenses. The UV absorption technology has been applied primarily to rigid, gas permeable lenses; however, most commercially available soft lenses do not contain UV absorbers.

Hydrogels are desirable for use in soft lenses. Typically, hydrogel contact lenses are manufactured by UV curing of mixture of hydrophilic monomers, which give the hydrogel property after hydration. It has been difficult to incorporate prior-art UV-absorbing compounds into hydrogels because these compounds are generally hydrophobic. UV absorbers are preferably copolymerized, rather than physically entrapped within the hydrogel, to prevent the absorber from being leached out of the UV-absorbing hydrogel when the hydrogel is in the aqueous environment of the eye or stored in solution. Thus, there is a need to provide radiation-absorbing compounds that are hydrophilic and compatibly polymerizable with hydrophilic monomers.

In addition, there is an unmet need to provide the user with the freedom to add a UV-absorbing characteristic to ophthalmic devices when such characteristic is desired. Therefore, it is very desirable to provide a solution to this unmet need. In another aspect, it is also very desirable to provide UV radiation- and blue light-absorbing compounds that are compatible with a hydrophilic environment to overcome the aforementioned shortcomings of prior-art UV radiation-absorbing compounds.

### SUMMARY OF THE INVENTION

In general, the present invention provides radiation-absorbing materials. In one embodiment, the present invention provides curable hydrophilic radiation-absorbing materials and an ophthalmic composition that comprises a curable hydrophilic UV radiation-absorbing material, or a curable hydrophilic blue light-absorbing material, or both.

In one aspect, the ophthalmic composition is a contact lens solution. The term “contact lens solution,” as used herein, encompasses without limitation a contact lens sterilizing or germicidal solution; a contact lens sterilizing and cleaning solution; a contact lens sterilizing and storing solution; a contact lens sterilizing, cleaning, and storing solution; and a contact lens cleaning and/or storing solution.

In another aspect, the hydrophilic UV radiation-absorbing material and the hydrophilic blue light-absorbing material are soluble in an aqueous solution.

In still another aspect, the radiation-absorbing material comprises a radiation-absorbing moiety and a hydrophilic moiety.

In yet another aspect, the present invention provides a method of imparting UV radiation- and/or blue light-absorbing characteristic to an ophthalmic device, such as a contact lens. The method comprises immersing the ophthalmic device in a solution that includes a hydrophilic UV radiation-absorbing material, or a hydrophilic blue light-absorbing material, or both, at the point of use. In one embodiment, the solution is a contact lens solution.

Other features and advantages of the present invention will become apparent from the following detailed description and claims.

### BRIEF DESCRIPTION OF THE DRAWINGS

FIG. 1 shows the UV absorption spectrum of a solution of Example 3 without UV absorber 2330-71.

FIG. 2 shows the UV absorption spectrum of a solution of Example 3 with UV absorber 2330-71 at a concentration of 0.1 weight percent.

FIG. 3 shows the UV absorption spectrum of a solution of Example 3 with UV absorber 2330-71 at a concentration of 0.05 weight percent.

FIG. 4 shows the UV absorption spectrum of a solution of Example 4 without UV absorber 2330-71.

FIG. 5 shows the UV absorption spectrum of a solution of Example 4 with UV absorber 2330-71 at a concentration of 0.1 weight percent.

FIG. 6 shows the UV absorption spectrum of a solution of Example 4 with UV absorber 2330-71 at a concentration of 0.05 weight percent.

FIG. 7 shows the UV absorption spectrum of a solution of Example 5 with UV absorber 2330-40 at a concentration of 0.05 weight percent.

FIG. 8 shows the UV absorption spectrum of a solution of Example 5 with UV absorber 2330-40 at a concentration of 0.01 weight percent.

### DETAILED DESCRIPTION OF THE INVENTION

In general, the present invention provides radiation-absorbing materials. In one embodiment, the present invention provides curable hydrophilic radiation-absorbing materials and an ophthalmic composition that comprises a curable hydrophilic UV radiation-absorbing material, or a curable hydrophilic blue light-absorbing material, or both.

In the present disclosure, the terms “radiation” and “light” are interchangeable and mean electromagnetic radiation. The term “lower alkyl” means a straight alkyl radical having 1 to, and including, 10 carbon atoms, or branched or cyclic alkyl radical having 3 to, and including, 10 carbon atoms. The term “blue light” means electromagnetic radiation having wavelength in the range from about 400 nm to about 500 nm. The term “water soluble” means capable of being completely dissolved in water at about 25° C. to an extent of at least about 10 g per 100 g of water.

In one embodiment, the ophthalmic composition is a contact lens cleaning solution. A contact lens cleaning solution of the present invention comprises at least a radiation absorber selected from the group consisting of water-soluble UV-radiation absorbers, water-soluble blue-light absorbers, and combinations thereof. The contact lens cleaning solution further comprises one or more materials selected from the group consisting of buffering agents, tonicity adjusting agents, surfactants, chelating and/or sequestering agents, viscosity modifiers, and humectants.

A water-soluble UV-radiation absorbers or blue-light absorber of the present invention comprises a UV radiation absorbing moiety or a blue light-absorbing moiety, as the case may be, and a hydrophilic moiety. In one embodiment, the radiation-absorbing moiety and the hydrophilic moiety are covalently bonded together.

In one aspect, the UV radiation-absorbing moiety is provided by a compound selected from the group consisting of benzophenones, benzotriazoles, benzoxazinones, oxanilides, benzylidene malonates, quinazolines, derivatives thereof, and combinations thereof. A compound having one of said moieties comprises at least a first reactive functional group that is capable of forming a covalent bond with a second reactive functional group on a compound having the hydrophilic moiety. Non-limiting examples of first and second reactive functional groups are vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof. Several benzophenones, benzotriazoles, and derivatives thereof are disclosed in U.S. Pat. No. 6,244,707, which is incorporated herein by reference in its entirety. Benzoxazinones, oxanilides, benzylidene malonates, quinazolines, and derivatives thereof are disclosed in published U.S. patent application Ser. No. 10/486,134, which is incorporated herein by reference in its entirety. Benzotriazoles and derivatives thereof that can be used in a composition of the present invention are represented generally by the following Formula (I): 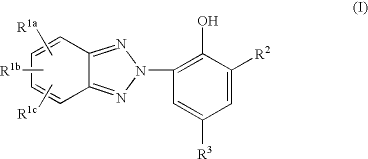
wherein R^{1a}, R^{1b}, and R^{1c} are independently selected from hydrogen, halogen, hydroxyl, C₁-C₆ straight or branched chain alkyl or alkoxy groups, C₆-C₃₆ aryl, and substituted aryl groups; R² is hydrogen, lower alkyl (preferably tert-butyl), aryl or substituted aryl; R³ is hydrogen, lower alkyl, aryl, substituted aryl, or R⁴—R⁵—R⁶, where R⁴ is a direct bond or oxygen, R⁵ is direct bond or a linking group selected from the group consisting of lower alkyl (preferably C₁-C₆ alkyl), —((CH₂)ₙO)ₘ—, —(CH(CH₃)CH₂O)ₘ—, —(CH₂CH(CH₃)O)ₘ—, —((CH₂)ₙOCH₂)ₘ—, —(CH(CH₃)CH₂OCH₂)ₘ—, and —(CH₂CH(CH₃)OCH₂)ₘ— group; n is 2 or 3; m is a positive integer in the range from 1 to, and including, 10; and R6 is selected from the non-limiting reactive groups disclosed above. In one embodiment, m is in the range from 1 to, and including, 5. In another embodiment, m is in the range from 1 to, and including, 3. In still another embodiment, R6 is selected from the group consisting of vinyl, acryloyloxy, and methacryloyloxy.

In one embodiment, the benzotriazole-based compound having the UV radiation-absorbing moiety is 2-[3′-t-butyl-5′(methacryloyloxypropyl)-2′-hydroxyphenyl]-5-chloro benzotriazole, represented by Formula (II).

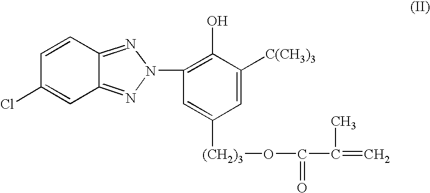

In another embodiment, the benzotriazole-based compound having the UV radiation-absorbing moiety is 2-[3′-t-butyl-5′(methacryloyloxyethyl)-2′-hydroxyphenyl]-5-chloro benzotriazole, represented by Formula (III).

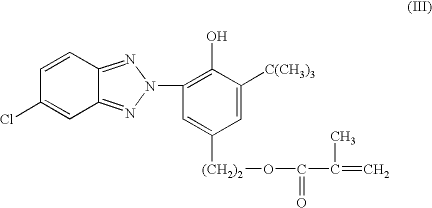

In still another embodiment, the benzotriazole-based compound having the UV radiation-absorbing moiety is 2-(2′-hydroxy-5′-methacryloylamido)phenyl benzotriazole represented by Formula (IV) below and disclosed in U.S. Pat. No. 4,719,248, which is incorporated herein by reference in its entirety.

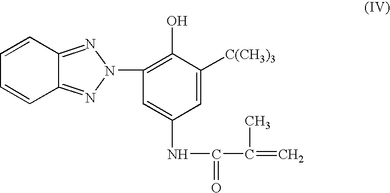

Benzotriazoles having a reactive vinyl group and a reactive methacryloyloxy group can be prepared by the method disclosed in U.S. Pat. Nos. 5,637,726 and 4,716,234, respectively. These patents are incorporated herein by reference in their entirety. Other reactive groups can replace the vinyl or methacryloyloxy groups.

Benzophenones and derivatives thereof that can be used in a composition of the present invention are represented generally by the following Formula (V): 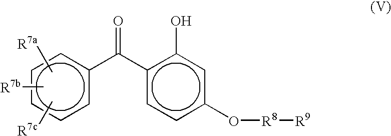
wherein R^{7a}, R^{7b}, and R^{7c} are independently selected from the group consisting of hydrogen, halogen, hydroxyl, C₁-C₆ straight or branched chain alkyl, C₁-C₆ straight or branched chain alkoxy groups, C₆-C₃₆ aryl, and substituted aryl groups; R⁸ is a direct bond or a linking group selected from the group consisting of lower alkyl, —((CH₂)ₙO)ₘ—, —(CH(CH₃)CH₂O)ₘ—, —(CH₂CH(CH₃)O)ₘ—, —((CH₂)ₙOCH₂)ₘ—, —(CH(CH₃)CH₂OCH₂)ₘ—, and —(CH₂CH(CH₃)OCH₂)ₘ— groups; n is 2 or 3; m is a positive integer in the range from 1 to, and including, 10; and R⁹ is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof. In one embodiment, m is in the range from 1 to, and including, 5. In another embodiment, m is in the range from 1 to, and including, 3. In still another embodiment, R⁹ is selected from the group consisting of vinyl, acryloyloxy, and methacryloyloxy.

A desirable benzophenone-based compound having the UV radiation-absorbing moiety is 2-hydroxy-4methacryloyloxy-benzophenone, which is represented by Formula (V):

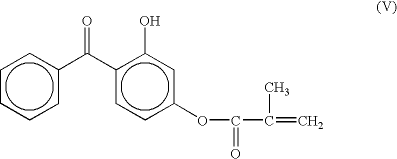

Benzophenones having a reactive methacryloyloxy group can be prepared by the method disclosed in U.S. Pat. No. 3,162,676, which is incorporated herein by reference in its entirety. Benzophenones having other reactive groups can be similarly prepared.

A water-soluble UV-radiation absorber of the present invention comprises a reaction product of a compound having a UV radiation-absorbing moiety having a first reactive functional group, such as one of the benzotriazoles or benzophenones disclosed above, and a hydrophilic compound having a second reactive functional group capable of reacting with the first reactive functional group. In one aspect, the water-soluble UV-radiation absorber is a copolymer of such a compound having a UV radiation-absorbing moiety and such a hydrophilic compound. The copolymer preferably has an average molecular weight in the range from about 1,000 to about 100,000, and more preferably, from about 5,000 to about 70,000. Non-limiting examples of hydrophilic compounds that are suitable for embodiments of the present invention include hydrophilic vinylic monomers, such as hydroxy-substituted lower alkyl acrylates and methacrylates, acrylamide, methacrylamide, lower alkyl acrylamides and methacrylamides, ethoxylated acrylates and methacrylates, hydroxy-substituted lower alkyl acrylamides and methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, amino- (the term “amino” also including quaternary ammonium), mono-lower alkylamino- or di-lower alkylamino-lower alkyl acrylates and methacrylates, allyl alcohol and the like. Hydroxy-substituted C2-C4 alkyl(meth)acrylates, five-to seven-membered N-vinyl lactams, N,N-di-C1-C4 alkyl(meth)acrylamides and vinylically unsaturated carboxylic acids having a total of from 3 to 10 carbon atoms. Specific examples of suitable hydrophilic vinylic monomers include hydroxyethyl methacrylate, hydroxyethyl acrylate, acrylamide, methacrylamide, N,N-dimethylacrylamide, allyl alcohol, vinylpyrrolidone, glycerol methacrylate, N-(1,1-dimethyl-3-oxobutyl)acrylamide, and the like. Preferred hydrophilicvinylic comonomers are 2-hydroxyethyl methacrylate, N-vinylpyrrolidone, and dimethylacrylamide.

A water-soluble blue-light absorber comprises at least a blue light-absorbing moiety and at least a hydrophilic moiety. The hydrophilic moiety can be selected from the group of hydrophilic monomers disclosed above. A compound having a blue light-absorbing moiety and a hydrophilic monomer are reacted in a manner similar to that disclosed above to produce a hydrophilic copolymer having blue light-absorbing property. The compound having a blue light-absorbing moiety preferably also includes a reactive functional group that facilitates the copolymerization with the hydrophilic monomer.

Yellow dyes generally comprise blue light-absorbing moieties and have blue light-absorbing characteristic. Non-limiting examples of such dyes are the azo dyes, such as those disclosed in U.S. Pat. No. 5,470,932 and published U.S. patent application Ser. No.10/236,584, which are incorporated herein by reference in their entirety. A compound having a blue light-absorbing moiety comprises at least a first reactive functional group that is capable of forming a covalent bond with a second reactive functional group on a compound having the hydrophilic moiety, such as one selected from the hydrophilic monomers disclosed above. Non-limiting examples of first and second reactive functional groups are vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof. Azo dyes having a reactive group can be made according to the method disclosed in U.S. Pat. No. 5,470,932 or a variation thereof wherein the methacryolyl group can be substituted with another reactive group. Suitable yellow dyes include N-2-[3′-(2″-methylphenylazo)-4′-hydroxyphenyl]ethyl vinylacetamide illustrated below in Formula (VI), N-2-[3′-(2″-methylphenylazo)-4′-hydroxyphenyl]ethyl maleimide illustrated below in Formula (VII), N,N-bis-(2-vinylacetoxyethyl)-(4′-phenylazo)aniline illustrated below in Formula (VIII), and N,N-bis-(2-allylcarbamatoethyl)-(4′-phenylazo)aniline illustrated below in Formula (IX).

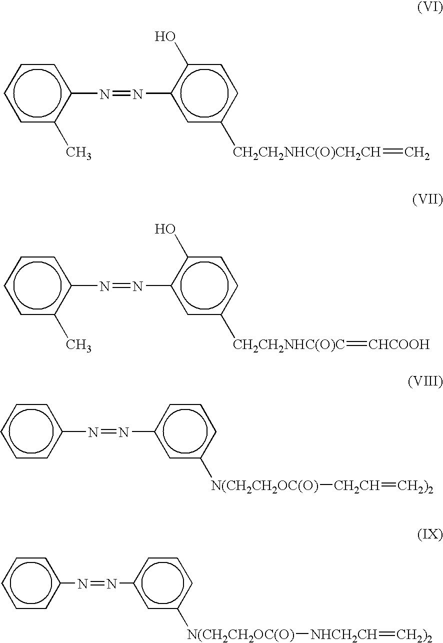

In another embodiment, a radiation-absorbing material comprises a copolymer of: (a) a radiation-absorbing compound having a radiation-absorbing moiety, such as a UV-absorbing or blue light-absorbing compound disclosed above; (b) a hydrophilic monomer; and (c) an additional monomer that has at least one free reactive functional group after such additional monomer has been incorporated into such the copolymer. The free reactive functional group of the additional monomer can be selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof. Such a free reactive functional group on the copolymer allows it to react with a complementary reactive functional group on a surface of an article to provide a radiation-absorbing surface layer, which may be continuous or discontinuous depending on the loading of the copolymer on the article. In one embodiment, such a radiation-absorbing layer is formed by immersing the article in a medium comprising the copolymer and allowing the reaction to take place.

A contact lens solution of the present invention comprises from about 0.001 to about 10 weight percent (preferably from about 0.01 to about 5 weight percent, more preferably from about 0.01 to about 2 weight percent) of a water-soluble UV-radiation absorber and/or blue-light absorber disclosed above. As disclosed above, the contact lens cleaning solution further comprises one or more materials selected from the group consisting of buffering agents, tonicity adjusting agents, surfactants, chelating and/or sequestering agents, viscosity modifiers, and humectants.

Any pharmaceutically acceptable buffer system may be utilized in the present invention and include phosphates, borates, acetates, citrate, and carbonates.

In a preferred embodiment, the buffer system includes at least one phosphate buffer and at least one borate buffer, which buffering system has a buffering capacity of 0.01 to 0.5 millimole (“mM”), preferably 0.03 to 0.45 mM, of 0.01 N of HCI and 0.01 to 0.3 mM, preferably 0.025 to 0.25 mM, of 0.01 N of NaOH to change the pH one unit. Buffering capacity is measured by a solution of the buffers only.

The pH of the present solutions should be maintained within the range of 5.0 to 8.0, more preferably about 6.0 to 8.0, most preferably about 6.5 to 7.8. By the terms “buffer” or “buffer substance” is meant a compound that, usually in combination with at least one other compound, provides a buffering system in solution that exhibits buffering capacity, that is, the capacity to neutralize, within limits, either acids or bases (alkali) with relatively little or no change in the original pH. The term “buffering capacity” is defined to mean the millimoles of strong acid or base (or respectively, hydrogen or hydroxide ions) required to change the pH by one unit when added to one liter (a standard unit) of the buffer solution. From this definition, it is apparent that the smaller the pH change in a solution caused by the addition of a specified quantity of acid or alkali, the greater the buffer capacity of the solution. The buffer capacity will depend on the kind and concentration of the buffer components.

Borate buffers include, for example, boric acid and its salts, for example, sodium borate or potassium borate. Borate buffers also include compounds such as potassium tetraborate or potassium metaborate that produce borate acid or its salt in solutions. Phosphate buffers include, for example, phosphoric acid and its salts, for example, phosphate buffers (including combinations of M2HPO4, MH2PO4 and MH2PO4, wherein M is independently an alkali metal such as K or Na). The term phosphate includes compounds that produce phosphoric acid or its salt in solution. As will be readily appreciated by the skilled artisan, buffering systems include but are not limited to the combination of a weak acid and the salt of the weak acid (the so-called conjugate base).

In another embodiment, the buffer system is the combination of boric acid and mono and/or dibasic phosphate salt such as sodium and/or disodium phosphate. An alternate buffer system, for example, is the combination of sodium borate and phosphoric acid or the combination of sodium borate and the monobasic phosphate.

Suitably, the solution comprises about 0.05 to 2.5 percent by weight of a phosphoric acid or its salt and 0.1 to 5.0 percent by weight of boric acid or its salt. The phosphate buffer is used (in total) at a concentration of 0.004 to 0.2 M, preferably 0.04 to 0.1 M. The borate buffer (in total) is used at a concentration of 0.02 to 0.8 M, preferably 0.07 to 0.2 M.

Other buffer substances may optionally be used in the composition. For example, traditionally known buffers include, for example, citrates, citric acid, sodium bicarbonate, tris(hydroxymethyl)aminomethane (“TRIS”), and the like. Generally, buffers will be used in amounts ranging from about 0.05 to 2.5 percent by weight, and preferably, from 0.1 to 1.5 percent.

Typically, the aqueous solutions of the present invention for cleaning, or otherwise treating, contact lenses are also adjusted with tonicity adjusting agents, to approximate the osmotic pressure of normal lachrymal fluids which is equivalent to a 0.9 percent solution of sodium chloride or 2.5 percent of glycerol solution. The solutions are made substantially isotonic with physiological saline used alone or in combination, otherwise if simply blended with sterile water and made hypotonic or made hypertonic the lenses will lose their desirable optical parameters. Correspondingly, excess saline may result in the formation of a hypertonic solution that will cause stinging and eye irritation. Examples of suitable tonicity adjusting agents include, but are not limited to, sodium and potassium chloride, dextrose, mannitol, sorbitol, glycerin, calcium and magnesium chloride, propylene glycol, and mixtures thereof. These agents are typically used individually in amounts ranging from about 0.01 to 2.5 percent (w/v) and preferably, form about 0.2 to about 1.5 percent (w/v). Preferably, the tonicity agent will be employed in an amount to provide a final osmotic value of 200 to 450 mOsm/kg and more preferably between about 250 to about 350 mOsm/kg, and most preferably between about 280 to about 320 mOsm/Kg.

Suitable surfactants are utilized in the practice of this invention and can be either cationic, anionic, amphoteric, or non-ionic. Non-limiting examples of suitable cationic surfactants include alkylamidopropyl phosphatidyl PG-diammonium chloride, alkyl phosphatidyl PG-diammonium chloride, and polyoxyethylene dihydroxypropyl alkylammonium chloride.

Non-limiting examples of anionic surfactants include sodium alkylbenzene sulfonates, sodium alkyl sulfates, sodium α-olefin sulfonates, sodium polyoxyethylene alkylether sulfates, sodium alkyloylmethyltaurinate, sodium alkyloylsarcosinate, sodium polyoxyethylene alkylether phosphates, sodium di(polyoxyethylene alkylether)phosphates, sodium polyoxyethylene alkylphenylether sulfates.

Non-limiting examples of amphoteric surfactants include alkoamphoglycinates, alkoamphocarboxyglycinates, alkoamphopropionates, alkoamphocarboxyproprionates, alkoamphopropylsulfonates, alkylbetaines, dihydroxyethylalkylglycinates, alkylamidopropylbetaines, alkylamidopropylhydroxysultaines, alkylaminoproprionates, alkylaminodiproprionates, alkylaminoacetate, and alkylaminodiacetates.

Non-limiting examples of non-ionic surfactants include polyoxyethylene higher fatty acid esters, higher fatty acid esters with polyoxyalkylene-polyoxyethylene copolymers, higher fatty acid esters with polyhydric alcohols, higher fatty acid esters with polyoxyethylene polyhydric alcohols such as polyoxyethylene glyceryl fatty acid esters, polyoxyethylene sorbitan fatty acid esters, polyglycerin fatty acid esters, polyoxyethylene alkyl ethers, polyglycerin ethers with alcohols, polyoxyethylene fatty acid amides, polyoxyethylene alkylamines, polyoxyethylene alkylphenyl ethers, condensate of polyoxyethylene alkylphenol ether with formaldehyde, polyoxyethylene-polyoxypropylene block copolymers, polyethyleneglycol adduct of hydrogenated castor oil, and polyoxyethylene sorbitan fatty acid esters.

In practice, cleaning compositions for soft hydrogel contact lenses are generally in the viscosity range of about 1 cp (centipoise or mPa.s) to about 50 cp. Cleaning compositions for rigid contact lenses generally are more viscous than those for soft hydrogel lenses and range in viscosity from about 10 cp to about 400 cp. When higher consistency cleaning formulations are desired, viscosity modifiers may be employed. Examples of useful viscosity builders include, but are not limited to, hydroxyethylcellulose, hydroxypropylmethylcellulose, polyvinylpyrrolidone, polyvinylalcohol, and mixtures thereof.

In some instances, it may be desirable to include sequestering agents in a solution of the present invention in order to bind metal ions that might otherwise react with the lens and/or protein deposits and collect on the lens. They are usually added in amounts ranging from about 0.01 to about 0.2 weight percent. Non-limiting examples include ethylene diamine tetraacetic acid (“EDTA”) and its salts (e.g., disodium), gluconic acid, citric acid, tartaric acid and their salts (e.g., sodium salts), and organic phosphonate compounds.

In another embodiment, an ophthalmic solution of the present invention is a sterilizing solution that comprises, in addition to the UV-radiation and/or blue-light absorbers and one or more other ingredients disclosed above, at least a germicide, such as any known biguanide germicides and known quaternary ammonium salt germicides, which exhibit a high degree of compatibility with the contact lens, the eye, and the skin of the user, as well as a high degree of germicidal effect, and which do not cause undesirable trouble with the eye such as allergy. Any one of or any combinations of the biguanide germicides and the quaternary ammonium salt germicides can be suitably employed. Examples of the biguanide germicide include polyhexamethylene biguamide (PHMB), and biguamide polymer which is represented by the following formula (X) 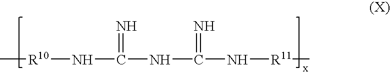
wherein x represents an integer greater or equal to 1 (preferably, 1≦x≦1000; more preferably, 1≦x≦500); and each of R¹⁰ and R¹¹ independently represents a divalent group represented by CᵢHⱼOₖ, wherein i=1-24, j=2-48, and k=0-11. A polymeric hexamethylene biguanide hydrochloride salt is commercially available from Zeneca (Wilmington, Del.) under the trade name Cosmocil™ CQ.

Some common non-polymeric biguanides and guanine-derived germicides are alexidine, chlorhexidine, picloxydine, and ambazone.

As the quaternary ammonium salt germicide, cationic surfactants are suitably used. The cationic surfactants include alkyl ammonium salts, such as tetraalkyl ammonium salts (e.g., alkyltrimethylammonium chloride) and trialkylbenzyl ammonium salts (e.g., octadecyl dimethylbenzyl ammonium chloride quaternary salts of alkylhydroxy alkylimidazoline whose typical example is hydroxyethyl alkylimidazoline chloride); alkylisoquinolinium salts (e.g., alkylisoquinolinium bromide); alkylpyridinium salts; and amideamines. An effective ammonium salt for use in a contact lens solution is benzyldimethyl{2-[2-(p-1,1,3,3-tetramethylbutylphenoxy)ethoxy)ethyl} ammonium chloride (“BDT”).

In still another embodiment of the present invention, a contact lens storing solution comprises at least one UV-radiation absorber and/or at least one blue-light absorber disclosed above, a buffering agent, and a tonicity-adjusting agent. The storing solution optionally can further comprise a material selected from the group consisting of surfactants, humectants, and combinations thereof.

### EXAMPLE 1

### Preparation of a high-molecular weight hydrophilic copolymer containing a hydrophilic monomer (N,N-dimethylacrylamide) and a UV absorbing monomer 2-[3′-t-butyl-5′-(methacryloxypropyl)-2′-hydroxyphenyl]-5-chloro benzotriazole

To a dry 1-liter, three neck round bottom flask were added, with anhydrous tetrahydrofuran (20 ml), N, N-dimethylacrylamide (7.9580 g, 80.4 mmole)) and (2-[3′-t-butyl-5′-(methacryloxypropyl)-2′-hydroxyphenyl]-5-chloro benzotriazole (1.5879 g, 3.705 mmole). The benzotriazole compound was prepared by a procedure described in Example 5 of U.S. Pat. No. 5,528,322, which is incorporated herein by reference in its entirety. The contents were bubbled with nitrogen for 30 minutes, then, 2,2′-azobisisobutyronitrile (Vazo-64 from DuPont, a free radical polymerization initiator, 0.0449 gram) was added and the contents were refluxed for 2 hours. The contents were then poured into 190 ml of ether to precipitate the product. It was then washed with ether. The final product was dried in a vacuum oven overnight. Size exclusion chromatography showed that Mn (number average molecular weight) was 27,492 and Mw (weight average molecular weight) was 65,966 (Sample 2330-40).

### EXAMPLE 2

### Preparation of a low-molecular weight hydrophilic copolymer containing a hydrophilic monomer (N,N-dimethylacrylamide) and a UV absorbing monomer 2-[3′-t-butyl-5′-(methacryloxypropyl)-2′-hydroxyphenyl]-5-chloro benzotriazole

To a dry 1-liter, 3-neck round bottom flask were added, with anhydrous tetrahydrofuran (50 ml), N, N-dimethylacrylamide (19.96 g, 201.6 mmole) and (2-[3′-t-butyl-5′-(methacryloxypropyl)-2′-hydroxyphenyl]-5-chloro benzotriazole (1.6118 g, 3.761 mmole). The benzotriazole was prepared by the procedure described in Example 5 of U.S. Pat. No. 5,528,322. The contents were bubbled with nitrogen for 15 minutes, then, 2,2′-azobisisobutyronitrile (Vazo-64, 0.0449 g) and mercaptoethanol (0.265 ml, or 0.2957 g, or 3.785 mmole) was added and the contents were refluxed overnight. Infrared analysis indicated no vinyl peak (at 1616 cm-1) remaining. The contents were poured into 500 ml of ether to precipitate the product. It was then redissolved in methylene chloride and then reprecipitated into ether. The final product (white powder) was dried in a vacuum oven overnight (Sample 2330-71).

### EXAMPLE 3

### Preparation of Solution for Cleaning and Disinfecting Contact Lenses

Two solutions were prepared which contained the following ingredients:

| Ingredient | Concentration (weight percent) |
|---|---|
| sodium borate | 0.09 |
| boric acid | 0.64 |
| sodium chloride | 0.49 |
| sodium EDTA | 0.11 |
| Tetronic 1107¹ | 1 |
| UV absorber 2330-71 | 0.1 and 0.05 |
| PHMB | 1.2 × 10⁻⁴ |

Note:
¹poly(oxypropylene)-poly(oxyethylene) ethylene diamine (or poloxamine) having a molecular weight of about 14,500, available from BASF Wyandotte Corp.

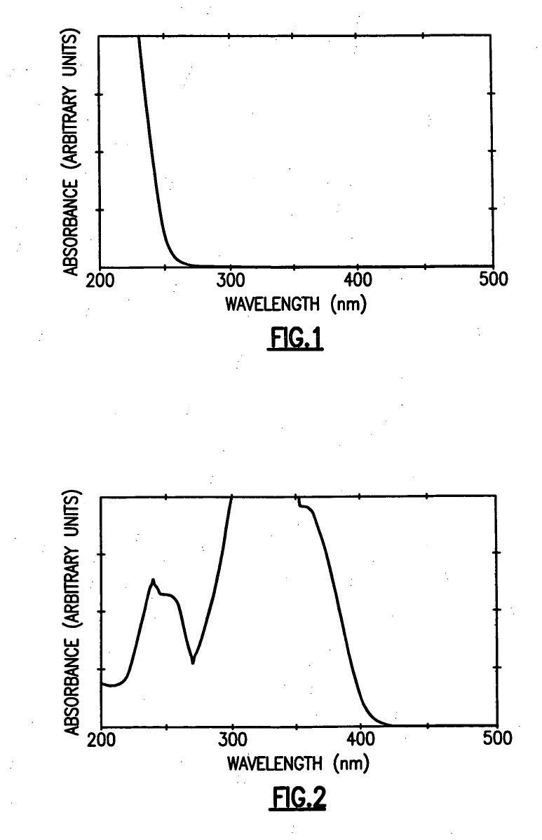

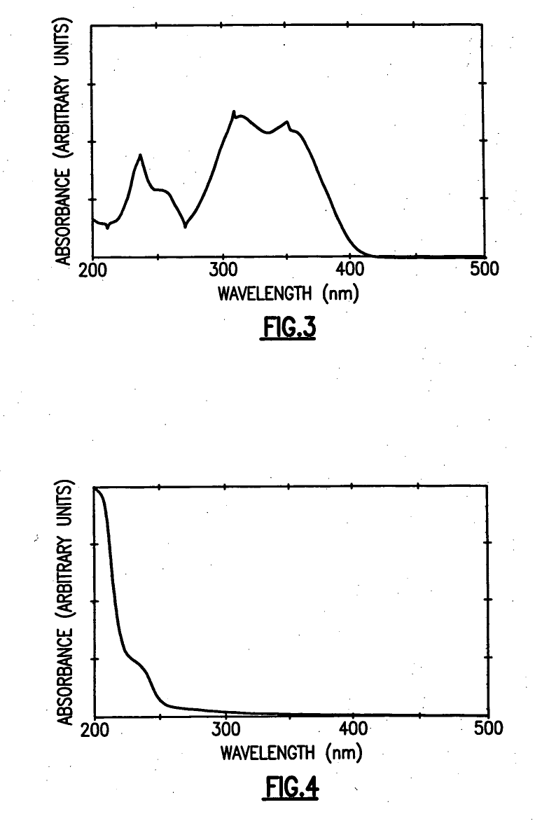

UV absorption spectra of the solution without UV absorber 2330-71 and with the UV absorber at concentration of 0.1 and 0.05 weight percent are shown in FIGS. 1, 2, and 3, respectively. The solutions with the UV absorber show strong absorption in the wavelength range from about 220 nm to about 380 nm.

### EXAMPLE 4

### Preparation of Solution for Cleaning and Disinfecting Contact Lenses

Two solutions were prepared which contained the following ingredients:

| Ingredient | Concentration (weight percent) |
|---|---|
| boric acid | 0.85 |
| sodium phosphate (monobasic) | 0.15 |
| sodium phosphate (dibasic) | 0.31 |
| sodium chloride | 0.2 |
| Polymer JR 125¹ | 0.02 |
| HAP (30 percent)² | 0.1 |
| Pluronic F1273³ | 2 |
| Tetronic 1107 | 1 |
| alexidine 2HCl | 4.5 × 10⁻⁴ |
| UV absorber 2330-71 | 0.1 and 0.05 |

Notes:
¹a cationic polysaccharide that can be obtained from Dow Chemical Company, Midland, Michigan. Other suitable polysaccharides are Polymer JR 400, Polymer JR 30M, Polymer LR 30M, and Polymer LK.
²a hydroxyalkylphosphonate, a useful class of surfactants and/or chelating agent, such as those disclosed in U.S. Pat. No. 5,858,937, available under the trade name Dequest ® (Monsanto Co., St. Louis, Missouri); preferable Dequest ® 2016.
³a primary hydroxyl-terminated copolymer nonionic surfactant having an average molecular weight of about 12,600, available from BASF Corporation, Mount Olive, New Jersey.

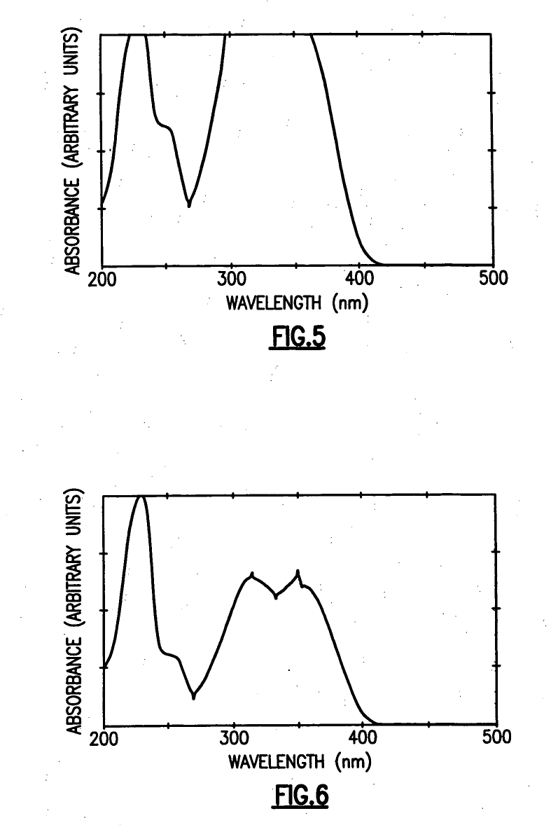

UV absorption spectra of the solution without UV absorber 2330-71 and with the UV absorber at concentration of 0.1 and 0.05 weight percent are shown in FIGS. 4, 5, and 6, respectively. The solutions with the UV absorber show strong absorption in the wavelength range from about 220 nm to about 380 nm.

### EXAMPLE 5

### Preparation of Solution for Cleaning and Disinfecting Contact Lenses

Two solutions were prepared which contained the following ingredients:

| Ingredient | Concentration (weight percent) |
|---|---|
| boric acid | 0.85 |
| sodium phosphate (monobasic) | 0.15 |
| sodium phosphate (dibasic) | 0.31 |
| sodium chloride | 0.2 |
| Polymer JR | 0.02 |
| HAP (30 percent) | 0.1 |
| Pluronic F127 | 2 |
| Tetronic 1107 | 1 |
| alexidine 2HCl | 4.5 × 10⁻⁴ |
| UV absorber 2330-40 | 0.05 and 0.01 |

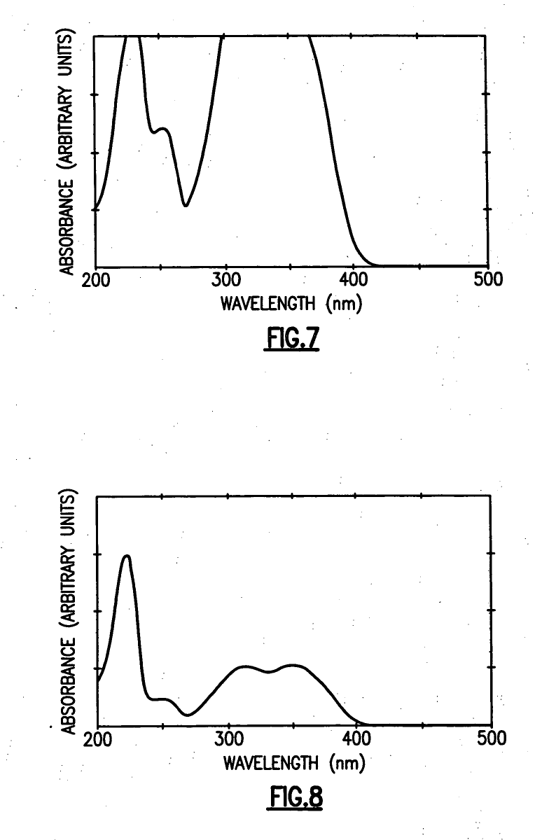

UV absorption spectra of the solution with UV absorber 2330-40 at concentration of 0.05 and 0.01 weight percent are shown in FIGS. 7 and 8, respectively. The solutions with the UV absorber again show strong absorption in the wavelength range from about 220 nm to about 380 nm.

### TOXICITY TESTING OF SOLUTIONS OF THE PRESENT INVENTION

Materials and Methods: All solutions were prepared from Bausch & Lomb formulation department. Madin-Darby canine were obtained from American Type Culture Collection (Manassas, Va.), ATCC#CCL34, and maintained in minimum essential medium (“MEM”) (BioWhittaker, Walkersville, MD) supplemented with 10 percent bovine calf serum in iron sullpemantation.

Sodium Fluorescein Permeability Assay: A 0.5 ml cell suspension containing 2×105 cells was seeded in Millicell HA 13-mm inserts (Millipore, Bedford, MA). The inserts were transferred into 24-well plates containing 0.5 ml of MEM per well. The plates were then incubated at 37° C. with 5 percent CO2 for 6 days. Fresh media was added to the wells on days 2 through 6. On day 6 the inserts were used for the permeability assay.

Each insert was gently rinsed three times with 1 ml of Hank's balanced salt solution (“HBSS”) using a 10-mL syringe, without a needle. An amount of 0.5 ml of test solution was added to separate inserts that had been placed in a fresh 24-well plate. Triplicate inserts were used for each test solution. The inserts were incubated in a 100 percent humidified chamber at 37° C. for 20 minutes. Each series of triplicate samples was handled sequentially to allow exact timing of the treatment and subsequent steps. After incubation, each insert was individually rinsed five times with 1 ml HBSS using a 10-ml syringe (without needle), and then placed in a fresh 24-well plate containing 0.5 ml HBSS in each well. To each insert was added 0.5 ml of sodium fluorescein (3 mg/100 ml in HBSS). The inserts were incubated at room temperature for 30 minutes, removed from the wells, and the amount of sodium fluorescein was measured using a fluorometer at 540 nm excitation and 590 nm emission. Triplicate negative controls (HBSS solution) and positive controls consisting of sodium dodecyl sulphate (“SDS”) in water were included during these evaluations.

| | | Fluorescence after |
|---|---|---|
| Sample | Fluorescence | 24 hours |
| Solution 1 | 70 ± 9¹ | 19 ± 3¹ |
| Solution 2 with 0.1 percent | 316 ± 65 | 23 ± 2 |
| 2330-71 | | |
| Solution 2 with 0.05 percent | 229 ± 44 | 25 ± 4 |
| 2330-71 | | |
| Solution 1 with | 48 ± 7 | 14 ± 4 |
| 0.05 percent 2230-71 | | |
| Solution 1 with 0.10 percent | 52 ± 9 | 15 ± 2 |
| 2230-71 | | |
| Solution 2 with 0.05 percent | 225 ± 16 | 22 ± 6 |
| 2230-40 | | |
| Solution 2 with | 293 ± 54 | 23 ± 3 |
| 0.10 percent 2230-40 | | |
| HBSS | 16 ± 3 | 12 ± 3 |

Note:
¹standard deviation

Conclusion: No toxicity has been found.

In another aspect of the present invention, a radiation-absorbing material that comprises a radiation-absorbing moiety and a hydrophilic moiety, as disclosed above, can be included in a composition, such as a sun blocking cream or lotion. Such a composition can be applied to human skin for protection against UV radiation.

Ophthalmic devices, such as contact lenses, are treated with a solution of the present invention for imparting a radiation-absorbing characteristic at the point of use. Such a solution can be formulated from a contact lens sterilizing or germicidal solution; a contact lens sterilizing and cleaning solution; a contact lens sterilizing and storing solution; a contact lens sterilizing, cleaning, and storing solution; and a contact lens cleaning and/or storing solution by adding and mixing therein a water-soluble radiation-absorbing material disclosed above.

The treatment comprises immersing the ophthalmic device in the solution for a time sufficient to achieve the cleaning and/or disinfecting effect. A time from about 2 hours to about 24 hours is typically adequate to achieve the cleaning and/or disinfecting effect, more typically from about 4 hours to 16 hours. The solution can be agitated to enhance the cleaning action while the ophthalmic device is immersed therein. Typically, the treatment is carried out at about room temperature. After the treatment period, the ophthalmic device is recovered and can be rinsed further with an amount of a fresh solution before it is placed in the eye. Alternatively, the ophthalmic device can be rinsed with a physiological saline solution.

If the solution is formulated from a storing solution for ophthalmic devices, they can be left immersed therein until they are ready to be placed in the eye. Similarly, it may be desirable to rinse the device with an amount of a fresh solution if such device had been used before.

While the ophthalmic device is immersed in a solution of the present invention, the radiation-absorbing material is deposited thereon and can form strong bonds with the surface of the ophthalmic device. Therefore, the solution provides a means for imparting the radiation-absorbing characteristic to only the chosen devices and only when a treatment is needed.

An ophthalmic solution of the present invention can be produced by a method comprising: (a) providing a liquid, at least a water-soluble radiation-absorbing material, and at least one other material selected from the group consisting of germicides, buffering agents, tonicity adjusting agents, surfactants, chelating and/or sequestering agents, viscosity modifiers, humectants, and combinations thereof; and (b) mixing together said liquid, said at least a water-soluble radiation-absorbing material, and said at least one other material. In one aspect, the liquid is an aqueous solution.

The ophthalmic solution can then be dispensed into individual containers under a sterilizing atmosphere, and the containers are sealed and are ready for use by wearers of ophthalmic devices.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A composition comprising a water-soluble radiation-absorbing material.

2. The composition of claim 1, wherein the composition is aqueous and the radiation-absorbing material comprises a radiation-absorbing moiety attached to a hydrophilic moiety.

3. The composition of claim 2, wherein the radiation-absorbing moiety is provided by a radiation-absorbing compound selected from the group consisting of benzophenones, benzotriazoles, benzoxazinones, oxanilides, benzylidene malonates, quinazolines, azo dyes, derivatives thereof, and combinations thereof.

4. The composition of claim 3, wherein the radiation-absorbing compound further comprises at least a first reactive functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof.

5. The composition of claim 3, wherein the radiation-absorbing moiety is provided by a radiation-absorbing compound selected from the group consisting of benzophenones, benzotriazoles, azo dyes, derivatives thereof, and combinations thereof, and wherein the radiation-absorbing compound further comprises a first reactive functional group selected from the group consisting of vinyl, allyl, acryloyl, acryloyloxy, methacryloyl, methacryloyloxy, and combinations thereof.

6. The composition of claim 5, wherein the radiation-absorbing compound is selected from the group consisting of compounds represented by Formulas (II), (III) and (IV), and combinations thereof

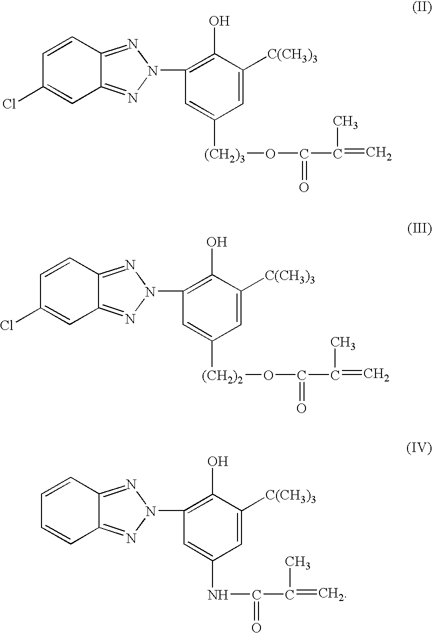

7. The composition of claim 5, wherein the radiation-absorbing compound is represented by Formula (V)

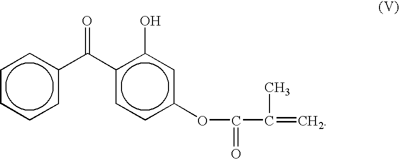

8. The composition of claim 5, wherein the radiation-absorbing compound is selected from the group consisting of compounds represented by Formulas (VI), (VII), (VIII), and (IX), and combinations thereof

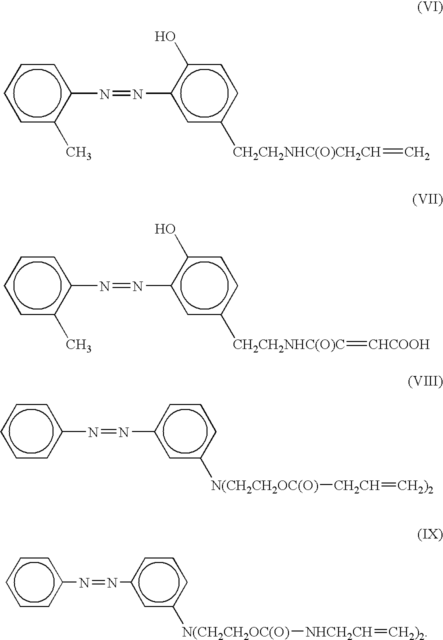

9. The composition of claim 2, wherein the hydrophilic moiety is provided by a hydrophilic monomer selected from the group consisting of hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, alkylamino acrylates, alkylamino methacrylates, allyl alcohol, and combinations thereof.

10. The composition of claim 2, wherein the hydrophilic moiety is provided by a hydrophilic monomer selected from the group consisting of acrylamide, methacrylamide, lower alkyl acrylamides, lower alkyl methacrylamides, hydroxy-substituted lower alkyl acrylamides, hydroxy-substituted lower alkyl methacrylamides, N-vinylpyrrolidone, and combinations thereof.

11. The composition of claim 2, wherein the radiation-absorbing material comprises a copolymer of: (a) a radiation-absorbing compound comprising the radiation-absorbing moiety; and (b) a hydrophilic monomer comprising the hydrophilic moiety.

12. The composition of claim 11, wherein the copolymer has a weight average molecular weight in a range from about 1,000 to about 100,000.

13. The composition of claim 11, wherein the copolymer has a weight average molecular weight in a range from about 5,000 to about 70,000.

14. The composition of claim 2, further comprising a buffering agent.

15. The composition of claim 14, further comprising a germicide.

16. The composition of claim 15, wherein the germicide is selected from the group consisting of biguanide germicides, guanine-derived germicides, quaternary ammonium salt germicides, and combinations thereof.

17. The composition of claim 15, wherein the germicide is selected from the group consisting of alexidine, chlorhexidine, picloxydine, ambazone, and combinations thereof.

18. The composition of claim 15, wherein the germicide is a polymer represented by Formula (X) 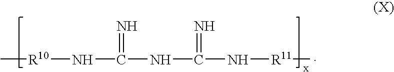
wherein x is an integer and 1≦x≦500; and each of R¹⁰ and R¹¹ independently represents a divalent group represented by CᵢHⱼOₖ, wherein i=1-24, j=2-48, and k=0-11.

19. The composition of claim 15, wherein the germicide is selected from the group consisting of tetraalkyl ammonium salts, trialkylbenzyl ammonium salts, alkylisoquinolinium salts, alkylpyridinium salts, amideamines, and benzyldimethyl{2-[2-(p-1,1,3,3-tetramethylbutylphenoxy)ethoxy]ethyl} ammonium chloride.

20. The composition of claim 14, further comprising a surfactant.

21. The composition of claim 20, wherein the surfactant is a nonionic poly(oxypropylene)-poly(oxyethylene) ethylene diamine surfactant.

22. The composition of claim 14, further comprising a tonicity-adjusting agent.

23. The composition of claim 14, further comprising a chelating agent.

24. The composition of claim 14, further comprising a viscosity modifier.

25. The composition of claim 14, further comprising a humectant.

26. An aqueous composition comprising:
(a) a radiation-absorbing material selected from the group consisting of water-soluble UV radiation-absorbing materials, water-soluble blue light-absorbing materials, and combinations thereof;
(b) a buffer agent; and
(c) a surfactant;
wherein the radiation-absorbing material comprises a copolymer of at least a radiation-absorbing compound and a hydrophilic monomer;
said at least a radiation-absorbing compound is selected from the group consisting of benzophenones, benzotriazoles, benzoxazinones, oxanilides, benzylidene malonates, quinazolines, azo dyes, derivatives thereof, and combinations thereof; said at least a radiation-absorbing compound further comprises a first reactive functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof;
the hydrophilic monomer is selected from the group consisting of hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substitued lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, alkylamino acrylates, alkylamino methacrylates, allyl alcohol, and combinations thereof; and
the copolymer has a weight average molecular weight in a range from about 1,000 to about 100,000.

27. The aqueous composition of claim 26, further comprising a germicide selected from the group consisting of biguanide germicides, guanine-derived germicides, quaternary ammonium salt germicides, and combinations thereof.

28. The aqueous composition of claim 27, wherein the germicide is selected from the group consisting of alexidine, chlorhexidine, picloxydine, ambazone, and combinations thereof.

29. A method of treating an ophthalmic device, the method comprising:
immersing the ophthalmic device in a composition that comprises a radiation-absorbing material selected from the group consisting of water-soluble UV radiation-absorbing materials, water-soluble blue light-absorbing materials, and combinations thereof;
wherein the radiation-absorbing material comprises a copolymer of: (a) a radiation-absorbing compound comprising the radiation-absorbing moiety;
and (b) a hydrophilic monomer comprising the hydrophilic moiety.

30. The method of claim 29, wherein the ophthalmic device is a contact lens.

31. The method of claim 29, wherein the composition further comprises a germicide selected from the group consisting of biguanide germicides, guanine-derived germicides, quaternary ammonium salt germicides, and combinations thereof.

32. The method of claim 31, wherein the ophthalmic device is a contact lens.

33. The method of claim 29, further comprising recovering the ophthalmic device from the composition; and rinsing the ophthalmic device with another composition.

34. The method of claim 29, wherein the step of immersing is carried out for a time sufficient to achieve an effect selected from the group consisting of cleaning the ophthalmic device, sterilizing the ophthalmic device, and combinations thereof.

35. A radiation-absorbing material comprising a radiation-absorbing moiety attached to a hydrophilic moiety.

36. The radiation-absorbing material of claim 35, wherein the radiation-absorbing moiety is provided by a radiation-absorbing compound selected from the group consisting of benzophenones, benzotriazoles, benzoxazinones, oxanilides, benzylidene malonates, quinazolines, azo dyes, derivatives thereof, and combinations thereof.

37. The radiation-absorbing material of claim 36, wherein the radiation-absorbing compound further comprises at least a first reactive functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof.

38. The radiation-absorbing material of claim 36 wherein the radiation-absorbing moiety is provided by a radiation-absorbing compound selected from the group consisting of benzophenones, benzotriazoles, azo dyes, derivatives thereof, and combinations thereof, and wherein the radiation-absorbing compound further comprises a first reactive functional group selected from the group consisting of vinyl, allyl, acryloyl, acryloyloxy, methacryloyl, methacryloyloxy, and combinations thereof.

39. The radiation-absorbing material of claim 35, wherein the hydrophilic moiety is provided by a hydrophilic monomer selected from the group consisting of hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, alkylamino acrylates, alkylamino methacrylates, allyl alcohol, and combinations thereof.

40. The radiation-absorbing material of claim 35, wherein the hydrophilic moiety is provided by a hydrophilic monomer selected from the group consisting of acrylamide, methacrylamide, lower alkyl acrylamides, lower alkyl methacrylamides, hydroxy-substituted lower alkyl acrylamides, hydroxy-substituted lower alkyl methacrylamides, N-vinylpyrrolidone, and combinations thereof.

41. The radiation-absorbing material of claim 35, wherein the radiation-absorbing material comprises a copolymer of: (a) a radiation-absorbing compound comprising the radiation-absorbing moiety; and (b) a hydrophilic monomer comprising the hydrophilic moiety.

42. The radiation-absorbing material of claim 41, wherein the copolymer has a weight average molecular weight in a range from about 1,000 to about 100,000.

43. The radiation-absorbing material of claim 35, wherein the radiation-absorbing material comprises a copolymer of: (a) a radiation-absorbing compound comprising the radiation-absorbing moiety; (b) a hydrophilic monomer comprising the hydrophilic moiety; and (c) an additional monomer having at least one reactive functional group that remains free after the additional monomer has been incorporated into the copolymer.

44. The radiation-absorbing material of claim 43, wherein the radiation-absorbing compound is selected from the group consisting of benzophenones, benzotriazoles, benzoxazinones, oxanilides, benzylidene malonates, quinazolines, azo dyes, derivatives thereof, and combinations thereof, and the radiation-absorbing compound further comprises a first reactive functional group; the hydrophilic monomer is selected from the group consisting of hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, alkylamino acrylates, alkylamino methacrylates, allyl alcohol, and combinations thereof; and said at least one free reactive functional group is selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, and combinations thereof.
